(19) United States
(12) Patent Application Publication
(10) Pub. No.: US 2014/0164267 A1
(43) Pub. Date: Jun. 12, 2014

(54) COMPLIANCE SERVICE

(71) Applicant: Optionality Holdings Inc., Road Town (VG)

(72) Inventor: Maria Gabriela Bianchini, Singapore (SG)

(73) Assignee: Optionality Holdings Inc., Road Town (VG)

(21) Appl. No.: 14/099,051

(22) Filed: Dec. 6, 2013

Related U.S. Application Data
(60) Provisional application No. 61/734,641, filed on Dec. 7, 2012.

(51) Int. Cl. G06Q 30/00

(52) U.S. Cl. CPC G06Q 30/018
USPC 705/317

(57) ABSTRACT

This disclosure describes, in part, an environment that allows users to simplify the process of preparing, managing and submitting filings to various receiving entities. Generally, the environment provides an overall service that allows users and/or companies the ability manage, prepare, submit and view filings to various receiving entities. In some implementations, the process of preparing filings is greatly simplified through the automatic collection of information about the company and its personnel that may then be verified and used to prepare the filings. In addition, the environment maintains the information to generate additional filings, rather than having to create each filing independently.

### CROSS-REFERENCE TO RELATED APPLICATIONS

This application claims the benefit of U.S. Provisional Application No. 61/734,641, filed Dec. 7, 2012 entitled “Compliance Service,” which is incorporated herein by reference in its entirety.

### BACKGROUND

With the continued globalization and regulation of the economy and companies, many companies are now required to submit regulatory filings and reports to many different regulatory agencies, self-regulatory organizations, exchanges, alternative marketplaces, internal departments, investors, boards of directors and shareholders in different states and countries. These filings can often be complex and require an extensive amount of detailed information, such as financial, corporate, personnel, disciplinary, etc. In addition, many regulatory agencies require periodic filings as well as supplemental filings upon the occurrence of specific events.

While a portion of the information often required on various regulatory filings is common across filings, currently each company must prepare each filing independent of the other and submit the filings to each individual regulatory agency or other requesting body. In addition, the company must undergo the difficult tasks of determining when the various scheduled recurring regulatory filings are due for different agencies as well as what events trigger supplemental filings for various regulatory agencies.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial diagram of an example computing environment that includes a server system and a client device communicatively connected via a network.

FIG. 2 is a pictorial diagram of an example user interface of a compliance service, according to an implementation.

FIG. 3 is a pictorial diagram of an example user interface for providing individual information to a compliance service, according to an implementation.

FIG. 4 is a pictorial diagram of an example user interface for providing company information to a compliance service, according to an implementation.

FIG. 5 is a pictorial diagram of an example user interface of a calendar for viewing upcoming filings and/or assignment due dates, according to an implementation.

FIGS. 6-8 are pictorial diagrams of example user interfaces for preparing a filing for submission to a receiving entity, according to an implementation.

FIG. 9 is a flow diagram of an example process for accessing a compliance service, according to an implementation.

FIGS. 10-12 is a flow diagram of an example process for preparing a filing for submission to a receiving entity, according to an implementation.

FIG. 13 is a pictorial diagram of an illustrative implementation of a server system that may be used in the computing environment of FIG. 1.

While implementations are described herein by way of example, those skilled in the art will recognize that the implementations are not limited to the examples or drawings described. It should be understood that the drawings and detailed description thereto are not intended to limit implementations to the particular form disclosed, but on the contrary, the intention is to cover all modifications, equivalents, and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

This disclosure describes, in part, an environment that allows users to simplify the process of viewing, preparing, managing, storing, comparing, and submitting filings to various regulatory agencies, as well as other entities that require and/or request reporting of information. A “filing,” as used herein, is any report, form or delivery of information to a receiving entity in which specific items of information are necessary to satisfy the filing as requested by the receiving entity. A “receiving entity” is any entity (e.g., regulatory agency, self-regulatory organization, exchange, financial services firm, alternative marketplace, internal department, investor, board of directors, shareholder, individual, etc.) that receives a filing from the environment described herein. Generally, the environment provides an overall service that allows users and/or companies the ability manage, prepare and submit filings to various receiving entities. In some implementations, the process of preparing filings is simplified through the automatic collection of publically available information that may then be verified and used to prepare the filings. In other implementations, the process of preparing filings is simplified through the collection, management and accessibility of divergent sources of internal and proprietary data, such as end of day position-level data for financial services firms, that may then be verified and used to prepare the filings. In addition, the environment maintains verified company information and/or information provided by users associated with the company to generate additional filings, rather than having to create each filing independently. The collection and management of company, personnel, disciplinary, financial, position-level, and other information needed for preparing and submitting filings to various receiving entities greatly reduces the time needed to prepare those filings, reduces the inaccuracy resulting from the current techniques used to prepare filings and provides a systematic process to manage the preparation and submission of filings to receiving entities.

As a general example, an account may be established for a company and one or more users assigned to manage and prepare filings with various regulatory agencies on behalf of the company. The user(s) may view collected information about the company, verify the collected information, change, supplement, delete or otherwise modify the collected information. Collected company information may be used to automatically provide at least a portion of the information needed in the filing and any needed additional information may be identified to the user. The user may either provide the information or assign a portion of the filing to another user for completion. Overall, the user can manage the preparation of the filing and keep track of what other users have been assigned to provide needed information for the filing. In addition, once the filing is complete and the information verified, the information and filing may be associated with the company and stored in the environment for later use with other filings.

As noted above, a filing is any report, form or delivery of information to a receiving entity in which specific items of information are necessary to satisfy the filing as requested by the receiving entity. For example, the following laws require internal and/or external filings: Sarbanes-Oxley, Dodd-Frank, the Volker Rule, the Foreign Account Tax Compliance Act (FATCA), Basel III, Stability II, the European Market Infrastructure Regulation (EMIR), the Canadian Code of Conduct, US PATRIOT Act, MiFID I and II, UK Bribery Act, Japanese Payment Services Act, National Payments Corporation of India, Hong Kong Multi-currency Clearance Act, Securities and Futures Act of Singapore, etc. A filing may also be used for internal and/or external regulatory audits. While the disclosure focuses on regulatory agencies and the submission of regulatory filings, this is only provided for ease of discussion and explanation. The implementations described herein may be used to provide filings of any type to various third parties.

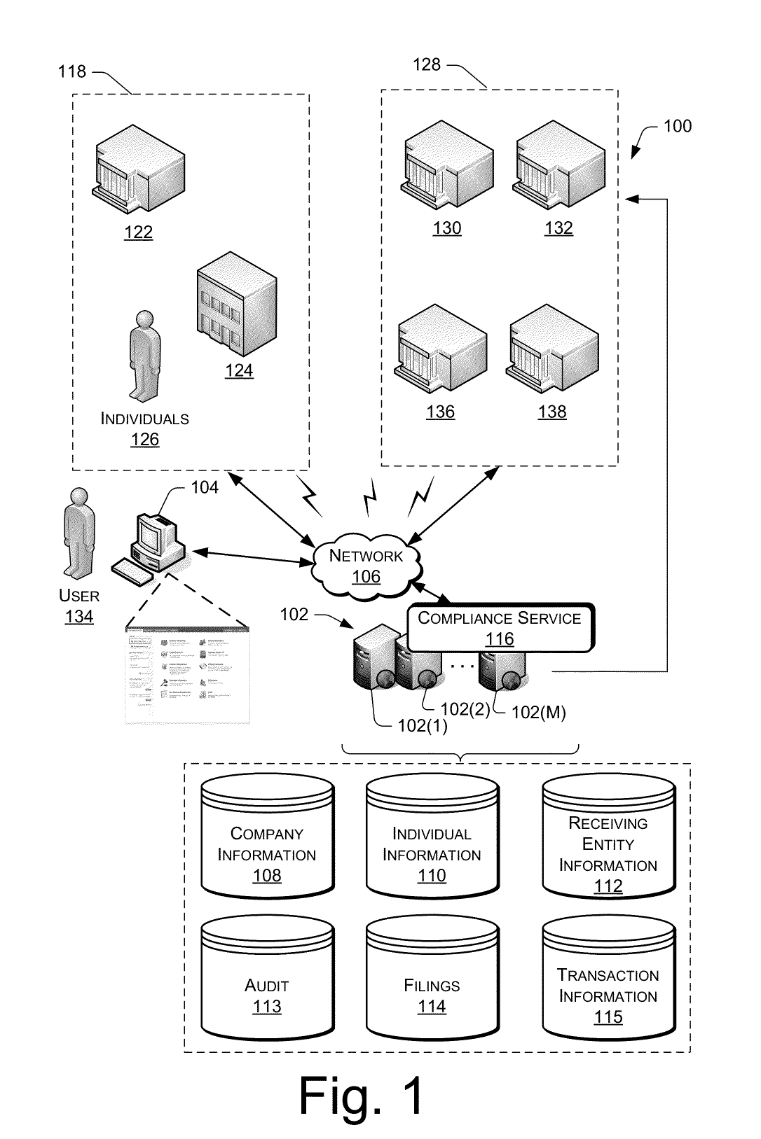

FIG. 1 is a pictorial diagram of an example computing environment 100 that includes a server system 102 with one or more server computers 102(1), 102(2)-102(M) and a client device 104 communicatively connected via a network 106. Although one server system 102 and one client device 104 are shown in FIG. 1, the computing environment 100 may include any number of server systems and client devices. The network 106 may include a local area network, a wide area network, such as a public switched telephone network (PSTN), a cable television network, a satellite network, a collection of networks, a public Internet protocol network, a private Internet protocol network, or a combination thereof. Moreover, the network 106 may be wired, wireless, or a combination of the two. The computing environment 100 may also include a company information data store 108, an individual information data store 110, an agency information data store 112, audit data store 113, a filings data store 114, and a transaction information data store 115. As used in this disclosure, the data stores may include lists, arrays, databases, and other data structures used to provide storage and retrieval of data. Likewise, while the disclosure describes multiple data stores, in some implementations the data stores may be configured as a single data store or multiple data stores.

The company information data store 108, individual information data store 110, agency information data store 112, audit data store 113, filings data store 114, and transaction information data store 115 may be integrated with the server system 102 or otherwise communicatively coupled with the server system 102. For example, one or more of the company information data store 108, individual information data store 110, agency information data store 112, audit data store 113, filings data store 114, and transaction information data store 115 may be located at a remote computing resource (not shown) and communicatively coupled with the server system 102. In some implementations, the company information data store 108, individual information data store 110, agency information data store 112, audit data store 113, filings data store 114, and transaction information data store 115 may include one or more CD-RW/DVD-RW drives, hard disk drives, tape drives, or other storage devices that are utilized to store digital content and information. The server system 102, separately or together with the company information data store 108, individual information data store 110, agency information data store 112, audit data store 113, filings data store 114, and transaction information data store 115, and may provide a compliance service 116 that facilitates preparation and submission of filings to various receiving entities 128.

The client device 104 may include a personal computer, a tablet computer, a laptop computer, a desktop computer, a netbook, a personal digital assistant (PDA), a wireless communication device, such as a smart phone or mobile handset, a set-top-box, or any combination thereof. As will be described with regard to the particular implementations shown herein, the server system 102 is configured to exchange data and information, including information about individuals, companies, receiving entities, filing deadlines, filing requirements, company personnel and other like information with the client device 104.

In some implementations, the server system 102 may also be configured to obtain information from one or more public sources 118. The public sources 118 may include governmental agencies 124, news agencies 122, individuals 126, public business filings, and the like. For example, the server system 102 may communicate with a news agency 122 to obtain public information about a company and/or personnel of that company for use in automating at least a portion of the processing and preparation of the information needed to complete a filing for submission.

In addition to communicating with various public sources, the server system 102 may also be configured to communicate directly with one or more receiving entities 128. As discussed above, a receiving entity is any entity (e.g., regulatory agency, self-regulatory organization, exchange, financial services firm, alternative marketplace, internal department, investor, board of directors, shareholder, individual, etc.) that receives a filing from the environment described herein. For example, receiving entities include, but are not limited to, regulatory agencies and self-regulatory organizations, such as the United States Securities and Exchange Commission (SEC), the Commodities and Future Trading Commission (CFTC), the US Treasury, the New York Stock Exchange (NYSE), the North American Securities Administrators Association (NASAA), the Financial Industry Regulatory Authority (FINRA), the Monetary Authority of Singapore (MAS), the Hong Kong Stock Exchange (HKSE), the European Securities and Markets Authority (ESMA), Bundesanstalt für Finanzdienstleistungsaufsichtthe (Germany's Federal Financial Supervisory Authority), the Financial Conduct Authority (FCA), the Financial Times and the London Stock Exchange (FTSE), the Securities and Exchange Board of India (SEBI), and the like. Receiving entities also include financial services firms, alternative marketplaces, internal departments, investors, boards of directors, shareholders, individuals, etc. In some implementations, a company may identify a country for which it is subject to regulatory filings and the server system 102 may identify the corresponding receiving entities (e.g., regulatory agencies) of that country and either associate those receiving entities with the company or allow the company to identify the receiving entities for which it submits filings.

Receiving entities 128 may provide information to the server system 102 identifying filing requirements, deadlines, necessary forms/questionnaires, events that require supplemental filings, and the like. In some implementations, receiving entities 128 may also provide information about companies that it maintains or has previously received from companies (e.g., previous filings) that can be collected and used by the company, via the compliance service 116, to prepare additional filings.

The company information data store 108 stores information identifying companies and information about those companies. For example, the company information data store may include information that identifies the company name, parent company names, subsidiary company names, sister/common control company names, country of formation/incorporation, regulatory agencies with jurisdiction over the company, other receiving entities for which the company provides filings, law firm(s) used by the company, accounting firm(s) used by the company, investment bank(s) used by the company, company custodian(s), trustee(s), administrator(s), advisors, vendors, location of business records, branch office information, personnel of the company, marketers, a list of historical regulatory filings, certifications, and the like. The information included in the company information data store 108 may be provided directly by the company, obtained from public sources and optionally verified by the company, obtained from other filings provided by the company, and the like.

The individual information data store 110 stores information associated with individuals, such as company personnel, users of the server system 102, clients of a company, customers of a company, etc. The individual information may include, but is not limited to, the individual's name, location, address, career, education level, degrees, current/past employer(s), current and past title(s)/position(s) with those employers, affiliations with agencies or other companies, list of past disclosures, historical information about the individual, financial information, investments held in the company, disciplinary information, work groups with which the individual are related, and the like. The information included in the individual information data store 110 may be provided directly by the company or companies with which the individual currently/previously was employed, obtained from public sources (e.g., social media) and optionally verified by the individual, obtained directly from the individual, etc.

The individual information maintained in the individual information data store 110 may be used by the server system 102 in completing a filing. For example, some regulatory filings require submission of information about key company personnel (e.g., Chief Executive Officer, Chief Technology Officer, General Counsel) and information maintained in the individual information data store 110 may be used to automatically prepare that information for filing.

In some implementations, users of the compliance service 116 may choose to limit whether their individual information can be utilized and shared with other companies as part of the completion of a regulatory filing. For example, in some implementations, if an individual changes jobs from one company to another, the individual may specify whether information already maintained by the compliance service 116 about that individual may be shared with and used by the new company in preparing and submitting a regulatory filing.

The receiving entity information data store 112 stores information relating to various receiving entities. For example, the receiving entity information data store 112 may include an identification of receiving entities, the corresponding country, the filing requirements for each receiving entity, the filing due dates, a list of forms or other information required to complete a filing, events that require filings, and the like. Receiving entity information may be obtained directly from the receiving entities 128, obtained from public sources 118 and/or obtained from other sources. The filings data store 114 stores information relating to forms or other information provided by or otherwise associated with receiving entities 128 that are to be completed as part of a filing that is submitted to the receiving entity.

The transaction information data store 115 stores information relating to activities of a company and/or user that utilizes the compliance service 116. For example, the transaction information data store 115 may maintain financial position data (e.g., corporate treasury positions, hedge fund positions), stock and/or exchange trading data for the company, foreign transaction data, etc. The information maintained in the transaction information data store 115 may be used in preparing filings for one or more receiving entities 128 and/or to determine when one or more filings may be required.

The audit data store 113 stores information relating to the use and verification of information about a company and/or individual. For example, the audit data store 113 may maintain an identification of an origin of information, the user that verified the information, the users that have utilized the information in a filing, the users that have certified the accuracy of the information, the users that have modified and/or added information, and the like. For each item of information utilized in a filing, audit information may be maintained in the audit data store 113 that will provide a chain of history identifying the individuals that have utilized, verified, modified and/or added information as well as the source of the information.

In some implementations, a user 134 of the client device 104 may interact with the compliance service 116 and view a list of filings that are due, or will be due, for one or more companies associated with that user. A user may be any person or organization. For example, a user may be a representative of a hedge fund, mutual fund, bank, company, private equity fund, etc. A user may also be a service provider that provides support to other users and/or companies that utilize the compliance service 116. For example, a user may also include individuals working at legal firms, brokers, fund administrators, accountants, vendors, etc. The user 134 may also identify any assignments, discussed below, that they have received for which input is needed or any assignments they have sent out for a filing they are preparing. Still further, the user 134 may be able to view information about themselves and/or the associated company and verify, correct, delete, modify and/or supplement that information.

In another implementation, a user 134 of the client device 104 may interact with the compliance service 116, for example by preparing one or more filings for a company, assign tasks or sections of a filing to other users of the service 116 for completion and/or complete tasks assigned to that user 134.

In still another implementation, a user 134 of the client device 104 may interact with the compliance service 116 and provide information about themself, correct, update, modify delete and/or verify stored information about themself.

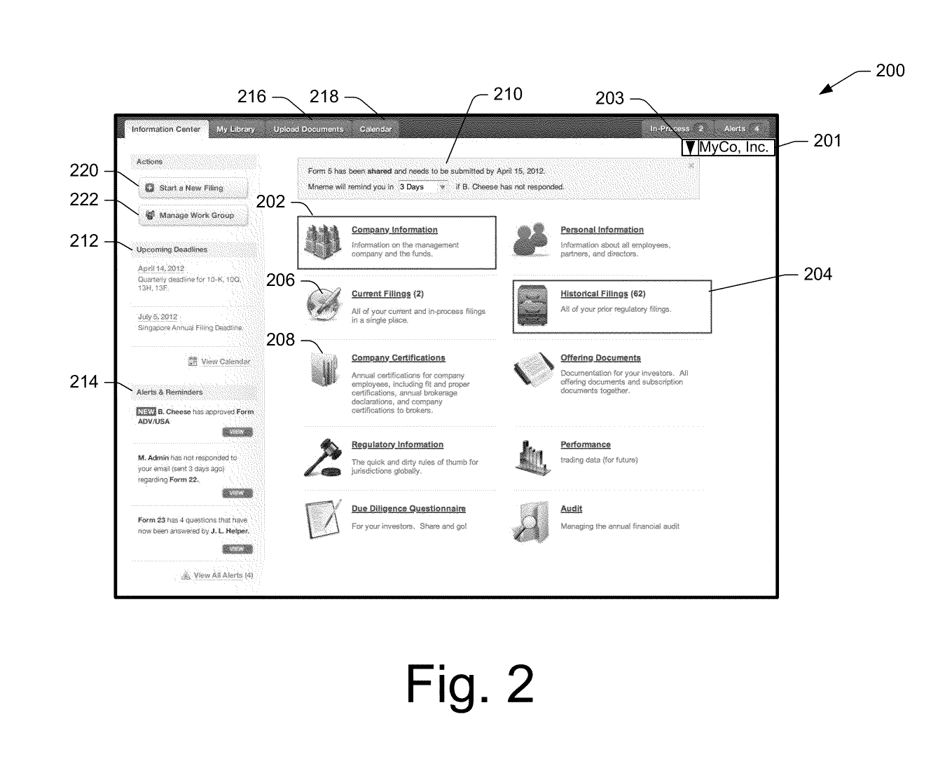

FIG. 2 is a pictorial diagram of an example user interface 200 of a compliance service, according to an implementation. The user interface 200 illustrates an example information center identifying to the user the various information that the user can access through the compliance service 116, the things the user can do within the compliance service 116 and information associated with or assigned to the user. In this example, the user is viewing information related to MyCo, Inc. 201. In some implementations, as discussed below, a user may be associated with multiple different companies and may view information for each of those companies and/or prepare filings for each of those companies. For example, if the user selects the company selection arrow control 203, the user can switch to other companies associated with the user.

For each associated company, the user can obtain information and/or perform actions on the company's behalf. For example, the user may select the Company Information control 202 and obtain information about MyCo, Inc. or select Historical Filings control 204 to view of list of filings that have previously been prepared and submitted on behalf of MyCo, Inc. Alternatively, the user may select the Current Filings control 206 and view a list of current filings, select the Company Certifications control 208 to view a list of annual certifications for company personnel, annual brokerage declarations, company certifications, and the like. There are a variety of other types of information that may be accessed from the example user interface 200, such as company regulatory information, personnel information, offering documents, etc. Such information may include unverified information (e.g., information from public sources or other third parties) and/or verified information (e.g., information provided by a company representative or other information that has been verified by an authorized company representative as accurate). Unverified information may be distinguished as unverified and a user, if authorized by the company, may verify the information as they utilize the compliance service 116. When information has been verified, audit information may be included in the audit data store 113 identifying the user that verified the information as well as the source of the information.

In addition to viewing information about the company (e.g., MyCo, Inc.), the user may also view information directly associated with the user. For example, the message box 210 may be utilized to provide information to the user regarding assignments or other actions related to the user. In this example, the message box 210 informs the user that “Form 5 has been shared and needs to be submitted by Apr. 15, 2012” and that a reminder will be provided if the assigned party has not provided a response within “3 days.” The user may modify the reminder date, re-assign the assignment and/or add other reminders that are to be sent to the user or the user that has received the assignment.

The user may also view upcoming deadlines 212 for the company as well as see other reminders and/or alerts 214 associated with the user. The example user interface 200 may also provide the user the ability to perform certain actions with respect to the company. For example, the user may upload documents 216, view a calendar 218, start a new filing 220 and/or manage a work group 222, as a few examples. Uploading documents, viewing calendars, starting filings and managing work groups is discussed in more detail below. While the example user interface provides an illustrative view of information that can be accessed by the user and actions that can be performed, any configuration or structure may be utilized. Likewise, additional or fewer items of information may be accessible through the example user interface.

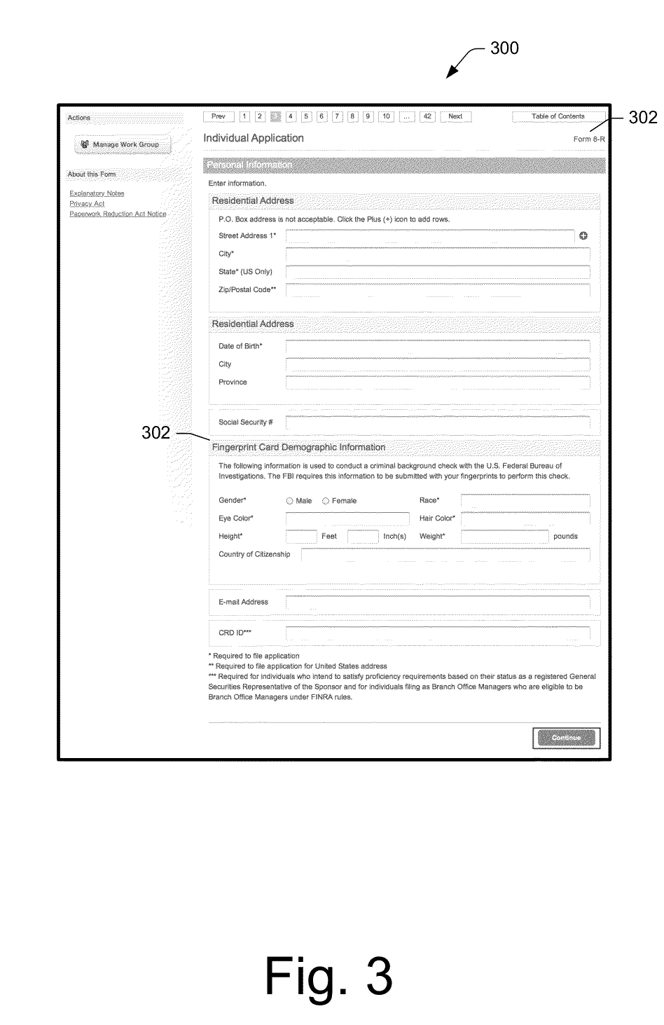

FIG. 3 is a pictorial diagram of an example user interface 300 for providing individual information to a compliance service 116, according to an implementation. As illustrated, FIG. 3 shows one of 42 pages of information that are necessary to complete a Form 8-R 302 filing for the receiving entity Commodity Futures Trading Commission (“CFTC”). Typically, this is a form document that is manually completed by the individual and then the information must be input into the agency's electronic filing system.

Many other receiving entities around the world require different portions of the information required for this Form 8-R. Rather than requiring the user to manually prepare each form separately and then submit the information to each different agency, which typically requires the user enter the same information multiple times, the implementations described herein collect some or all of the information on the user's behalf, populate the forms and allow the user to verify, correct, modify and/or update the forms. As one form is updated and verified, the information is maintained in the individual information data store 110 and used to populate other forms that are needed by the individual.

In addition, in some implementations, rather than the user having to manually input the completed information into the CFTC's system, or other receiving entity's system, the compliance service 116 may communicate directly with the receiving entity and provide submission of the information for the individual or company.

In addition to simplifying the collection of information and preparation of filings for various receiving entities, in some implementations, the compliance service 116 may provide information to help the user in obtaining the necessary information. For example, Form 8-R requires individuals to provide Fingerprint Card Demographic Information 304. The compliance service 116, in some implementations, may include the ability to provide additional information to the user to provide guidance as to where they can obtain the necessary information. For example, the compliance service 116 may determine the user's location (e.g., GPS, user provided, cellular triangulation) and identify locations near the user where they can go to obtain the necessary fingerprint card demographic information.

The compliance service may also allow a user to transfer or associate their individual information with another company. For example, if a user changes jobs from Company A to Company B, rather than the user having to complete a new regulatory filing identifying the job change, which would require collection of the individual's information again, the compliance service 116 may associate the user's account and the corresponding individual information maintained in the individual information data store 110 with the new company. As another example, if a client opens a new subsidiary in a new country or re-domiciles, the client can authorize the company to automatically transfer relevant information into the new country documentation for account opening, without the client having to re-create documentation that exists in different jurisdictions. The user, or another person acting on behalf of the new company, may then easily prepare the needed filing as all the necessary information is already maintained and available.

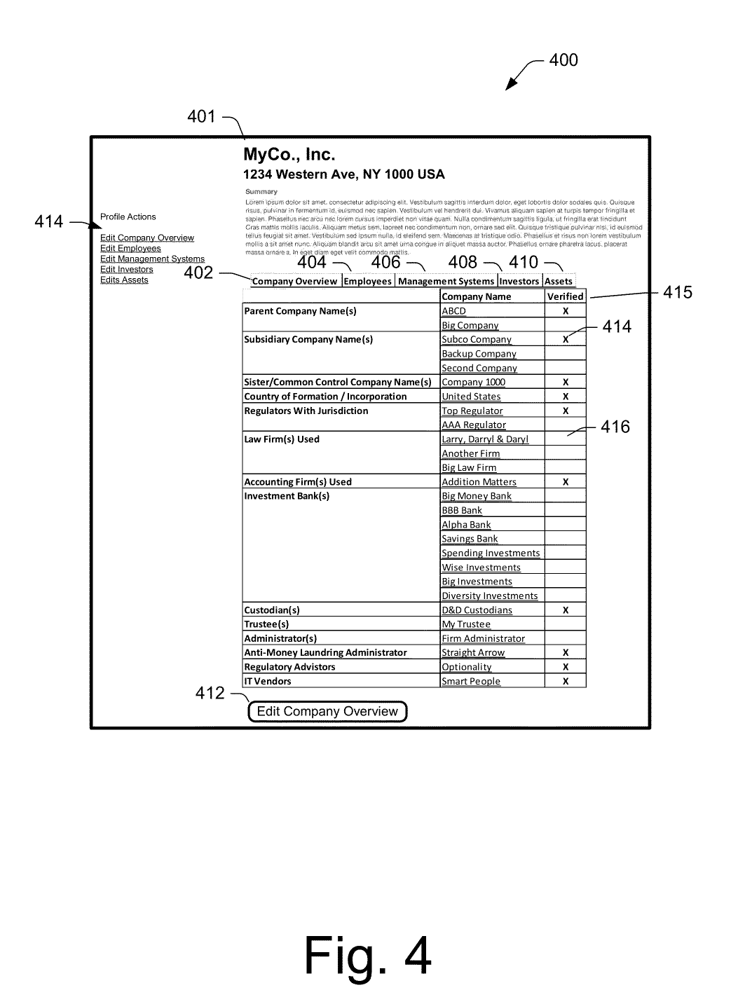

FIG. 4 is a pictorial diagram of an example user interface 400 for providing company information to a compliance service 116, according to an implementation. As illustrated in the example user interface 400, a user can view detail information about a company with which they are associated. In some implementations, users may have different levels of access to company information. For example, executive members of a company may be able to see all company information maintained by the compliance service 116, where external users associated with the company may have access to only a portion of the company information.

In this example, a user is associated with MyCo, Inc. 401 and can view information about the company in the Company Overview 402, view employee information by selecting the Employees tab 404, view management information by selecting the Management Systems tab 406, view information about investors by selecting the Investors tab 408, and view asset information by selecting the Asset tab 410. The user may also identify whether the information has been verified. As noted above, this information may be obtained from public or other third party sources (referred to herein as unverified information) or obtained from the company and/or a company representative (referred to herein as verified information). Information that has previously been viewed by the user, or another user authorized to verify information on behalf of the company, and confirmed as accurate may be identified as verified. For example, the verified column 415 may include confirmation boxes identifying whether the information has been verified. Verified information may be identified by a confirmation box filled with an “X,” such as confirmation box 414, or any other identifier. Unverified information may be identified by an empty confirmation box, such as empty confirmation box 416.

Information that is originally unverified may be reviewed, updated, changed, deleted and/or verified by a representative of the company. Collecting unverified company information and allowing a company representative to verify the information simplifies the process of inputting information necessary for preparing filings and maintained accuracy be requiring specific verification of information. In addition, the company information, once verified, may be used in preparing filings for various receiving entities. Once verified via user interaction with the user interface 400 or during preparation of a filing, the information is updated in the company information data store 108 and can then be used to automatically prepare subsequent filings for receiving entities. Audit information is also maintained in the audit data store 113 and the confirmation control is filled.

A user may edit company information through selection of the Edit Company Information control 412 or one of the edit controls 414. In some implementations, only certain authorized users may have the ability to edit and/or verify company information. An identification of the user that verified information and/or modified company information may be maintained in the audit data store 113.

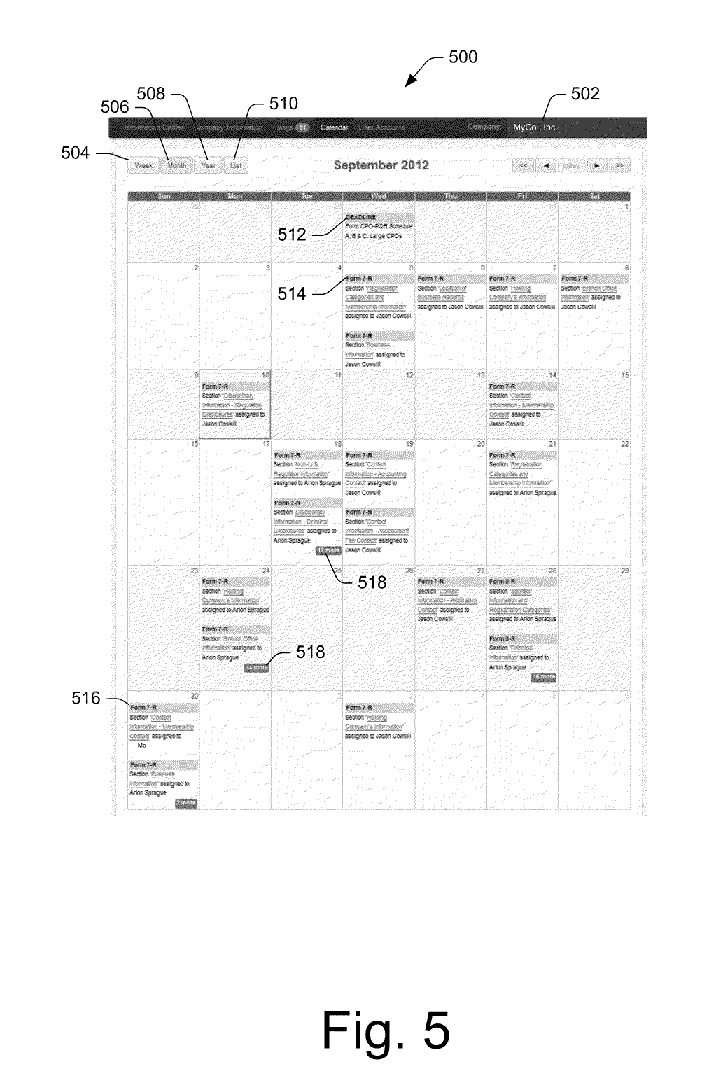

In addition to providing company information, such as the company name, subsidiary company names, etc. in some implementations, a user associated with the company may identify the receiving entities to which the company submits filings. In other implementations, the receiving entities may identify the companies from which they receive filings. Regardless, the compliance service 116 may identify the receiving entities for the company and based on information stored in the agency information data store 112 and the company information data store 108 determine filings that the company will need to submit and the deadlines by which those filings are due. That information may be provided to users associated with the company in a variety of ways. For example, a calendar may be provided to a user identifying the filings associated with that user for the company on the days that they are due, as illustrated in FIG. 5.

FIG. 5 is a pictorial diagram of an example user interface 500 of a calendar for viewing upcoming regulatory filings and/or assignment due dates, according to an implementation. As illustrated in the user interface 500, a user may be provided a graphical representation that provides information on items that are due on various days. In this example, the user is viewing information related to MyCo, Inc. 502 on a monthly 506 basis. The user may manipulate the view of the calendar by selecting a week view 504, year view 508, or list view 510.

Different types of information may be provided in the graphical user interface 500 of the calendar, such as filing deadlines 512, assignment due dates 514 for sections of filings assigned by the user to other users, and/or assignment due dates 516 for sections of filings assigned to other users for completion. For each item, the user may obtain information by selecting the control or hyperlink that represents the displayed item. For days on the calendar that include multiple items, a “more items” control 518 may be represented. Upon selection of the more items control 518, the user may be provided with additional information about the items due on the corresponding day.

In some implementations, information from the compliance service 116 may be integrated with and accessible through third party calendaring systems. For example, as an alternative, or in addition to the calendar provided via the graphical user interface 500, the information may also be viewable and accessible via Microsoft Outlook, Google Docs, Apple iCal, or another third party calendaring application. In such implementations, the user may items that are due, or other information, and access the compliance service 116 by selecting one of those items.

In addition to being able to view company information and information about the user, in some implementations, the compliance service 116 provides the ability for users to prepare and submit filings to various receiving entities.

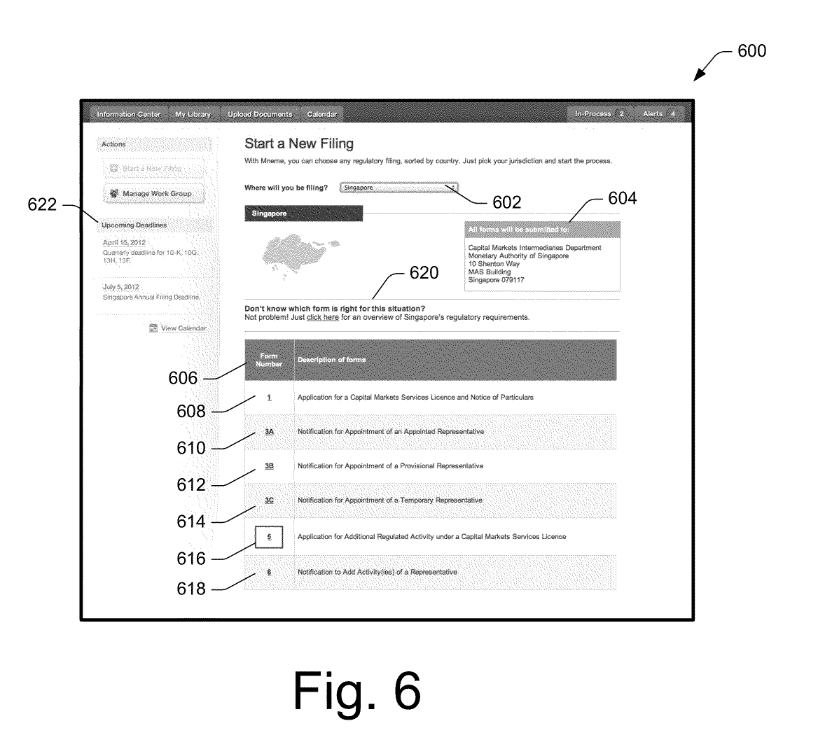

For example, FIGS. 6-8 are pictorial diagrams of example user interfaces 600-800 for preparing a filing for submission to a receiving entity, in this example a regulatory agency, according to an implementation. Turning first to FIG. 6, a user interface 600 is illustrated that allows a user associated with a company to select a regulatory filing to begin based on the country 602. The user in this example has selected to begin a regulatory filing in the country of Singapore. Based on the selected country, an identification of the regulatory agency 604 and the list of filings 606 that may be submitted to the regulatory agency are provided. For example, the Capital Markets Intermediaries Department Monetary Authority of Singapore 606 regulatory agency has several different associated filings that may be submitted, such as Form 1 “Application for a Capital Markets Services License and Notice of Particulars” 608, Form 3A “Notification for Appointment of an appointed Representative” 610, Form 3C “Notification for Appointment of a Temporary Representative” 612, Form 5 “Application for Additional Regulated Activity under a Capital Markets Service License” 614 and Form 6 “Notification to Add Activity(ies) of a Representative” 618. There may be many additional filings for the regulatory agency and the above list is provided only as an example.

Each of the filings 608-618 may require different information, although some of the requested information may be common for multiple filings. By maintaining a company information data store 108 and an individual information data store 110, common information can be automatically used to populate each filing, rather than the user having to input it into each individual application.

If the user is not sure which filing is needed for a particular situation, the user may select the help control 620 and obtain additional information regarding the filings and/or the regulatory agency's filing requirements. A user may also view the upcoming filing of deadlines 622 for the selected regulatory agency and/or country 602. By selecting any of the filings 608-618, a user may begin a filing process for the company. In this example, the user has selected to begin a filing based on Form 5 “Application for Additional Regulated Activity under a Capital Markets Services License” 616. Upon selecting Form 5, the compliance service 116 may query the company information data store 108, individual information data store 110, agency information data store 112, audit data store 113, filings data store 114, and transaction information data store 115 to initiate preparation of the materials for the selected filing. For example, the compliance service 116 may query the agency information data store 112, the filings data store 114 and the transaction information data store 115 to identify what information needs to be collected and prepared to complete the Form 5 filing. This may include an identification of a particular form or questionnaire and/or identification of a list of items that are needed.

Once the needed information is identified, the compliance service 116 may query the company information data store 108 and/or the transaction information data store 115 to collect unverified and/or verified information about the company that can be used in preparing the filing. In some implementations, unverified information about a company may be collected in advance, such as from public sources 118, and stored in the company information data store 108. In other implementations, the unverified information may be collected real-time as the filing is being prepared.

The compliance service 116 may also obtain unverified and/or verified information from the individual information data store 110 relating to personnel of the company. In some implementations, the company information maintained in the company information data store 108 may identify the personnel of the company for which information is to be included in a filing. From that information, the compliance service 116 may obtain individual information for the identified personnel from the individual information data store 110 for use in preparing the filing.

In instances where the compliance service 116 has both verified and unverified information (about an individual and/or company), the verified information may be used first in preparing the filing and the unverified information used to supplement the filing for any missing information.

In some implementations, the user may also be able to provide, submit and/or upload information relating to the company, personnel or other information for use in preparing the filing. For example, a user may have a copy of a previous filing that was prepared independently of the compliance service 116 that can be provided to the compliance service 116 for use in gathering information. In instances where a user provides information to the compliance service 116, the information may be added and compared against existing unverified and/or verified information.

Any differences between the user provided information, the unverified and/or verified information may be determined and identified to the user for resolution. In some implementations, the type of information (unverified, verified, user provided) may have different levels of priority. For example, unverified information may receive the lowest priority and any unverified information used in completing a filing may require verification by the user before the filing can be completed. Verified information may receive a higher level of priority and, in some implementations, may be automatically included in a filing and available for submission without specific verification. However, user provided information may receive the highest priority and any conflicts between verified information and user provided information may be identified and provided to the user to select the appropriate information. In other implementations, conflicts between user provided information and verified information (or unverified information) may be automatically resolved with the user provided information remaining and replacing the other information. The user provided information may then become the verified information.

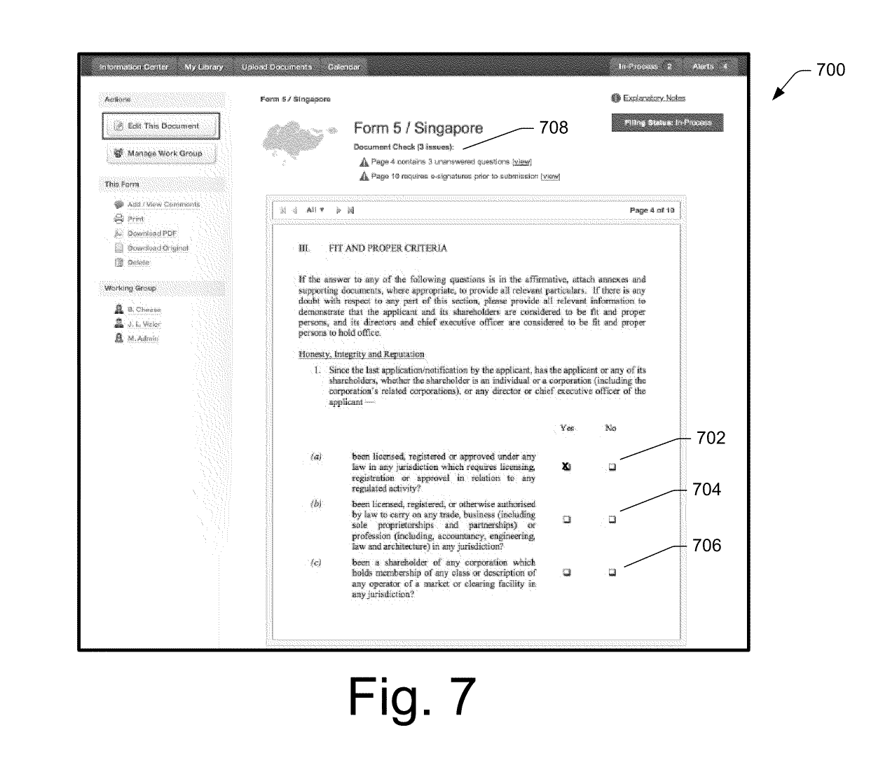

FIG. 7 illustrates a user interface 700 that identifies the different sections of a filing, in this example a section from Form 5, that are in the process of completion. For example, section 1(a) 702 is already completed and ready for submission, whereas section 1(b) 704 and section 1(c) 705 are not completed and need attention from the user. A section may need attention from the user if, for example, there is missing information, inconsistent information, or additional actions that need to be performed. For example, if a user has provided information that is inconsistent with verified information maintained by the compliance service 116, the compliance service 116 may identify the inconsistencies and ask the user to specify which item of information is to be used. Upon identification by the user, the selected information is marked as the verified information and updated in the appropriate data store of the compliance service 116.

The user interface may also provide information as to the total number of issues 706 that need to be addressed by the user before a filing can be completed. For each section of a filing that needs user attention, the user may complete those sections or assign them to other user's that are members of the work group associated with the company for which the filing is being prepared. As discussed below, a work group of one or more users may be established and associated with a company and/or a filing that is being prepared on behalf of the company. Members of the work group may access and participate in the preparation and submission of filings on behalf of the company. In some implementations, members of the work group may have different levels of authority or access. For example, some members of the work group may be limited to only providing information in response to receiving an assignment requesting the information. Modification of company information may be limited to specific members within the work group. Modification of individual information may be limited to only the corresponding individual and/or specific members within the work group. As will be appreciated, any variety, number and combination of user's may be included in a work group and different levels of access/authority may be assigned to those members.

In some implementations, a user may be a member of multiple work groups. For example, an attorney at a law firm that is not employed by a specific company may provide services to multiple companies. That individual may maintain one user account with the compliance service 116 and be associated with each of the different companies for which he provides services. In such an implementation, the user (the lawyer) can switch between companies and provide services to those companies without having to maintain multiple user accounts with the compliance service 116.

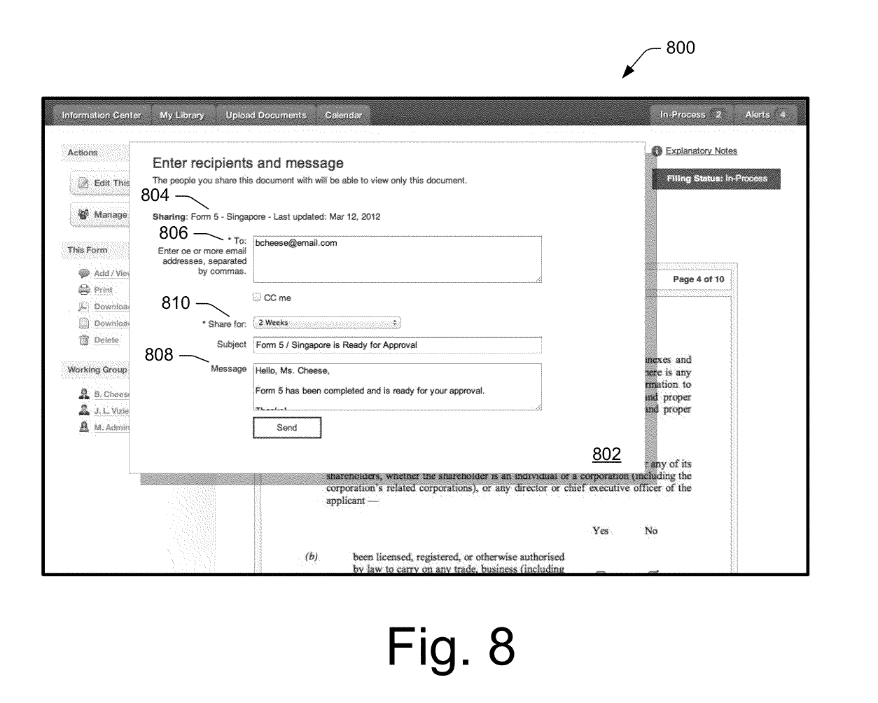

FIG. 8 is a pictorial diagram of an example user interface 800 in which a user may assign a section of a filing for completion to another user within a same work group, according to an implementation. In some implementations, a user may assign tasks or sections of a filing to other members of a work group for completion. In addition, the user may also be able to provide a note and/or due date specifying by when the information is to be provided or the section completed. In the example user interface 800, a user is preparing a message 802 to share 804 Form 5 with another user, Big Cheese 806, within the work group associated with MyCo, Inc. In this example the user is sharing the entire Form 5 with Big Cheese 806 because the user is asking for approval of the completed form. In other implementations, specific sections or portions of a filing may be selected for sharing. Also, the user with which the information is assigned/shared may only be able to view or access the shared information. In other implementations, the user receiving the information may be able to access all, or a larger portion of the filing.

In preparing to assign a section of a filing, the user may include a message 808 that will be provided to the user receiving the assignment. For example, the user may specify instructions or other information to the recipient of the assignment. In the example illustrated in FIG. 8, Form 5 has been completed and is being assigned to Big Cheese for approval prior to submission to the filing agency. In this example, the user has provided a message 808 stating that “Form 5 has been completed and is ready for your approval.” The user may also specify a duration 810 for the assignment identifying how long the information will be shared or specifying a due date as to when the recipient of the assignment is to complete the assignment.

As illustrated in FIG. 8, Form 5 has been completed and assigned to Big Cheese for approval prior to filing. Once Big Cheese has approved the materials, the assignment may be completed and the user notified. Once all the information and approvals have been completed, the user may cause the filing to be submitted to the appropriate receiving entity. In some implementations, submission may be done automatically. For example, the compliance service 116 may be in communication with the receiving entity and the user can submit the filing directly to the receiving entity (in this case a regulatory agency) through the compliance service 116. For example, a defined application programming interface (API) may be established through which filings may be directly submitted from the compliance service 116 to the receiving entity. In other implementations, the completed filing may be structured according to a predefined format specified by the receiving entity such that the user can electronically provide the information to the receiving entity. In still other implementations, the materials may be printed and delivered directly to the receiving entity. It will be appreciated that any number and combination of techniques may be used to submit filings to various receiving entities and those listed herein are provided only as examples.

Once the filing has been submitted and/or as information is verified, the information included in the filing is updated in the company information data store 108, the individual information data store 110 and audit information updated in the audit data store 113. This information is considered verified information and may be used by the compliance service to automatically prepare all or portions of other filings for use by the company. These filings may be for the same and/or different receiving entities. In addition, the filing itself is associated with the company and accessible as a historical filing.

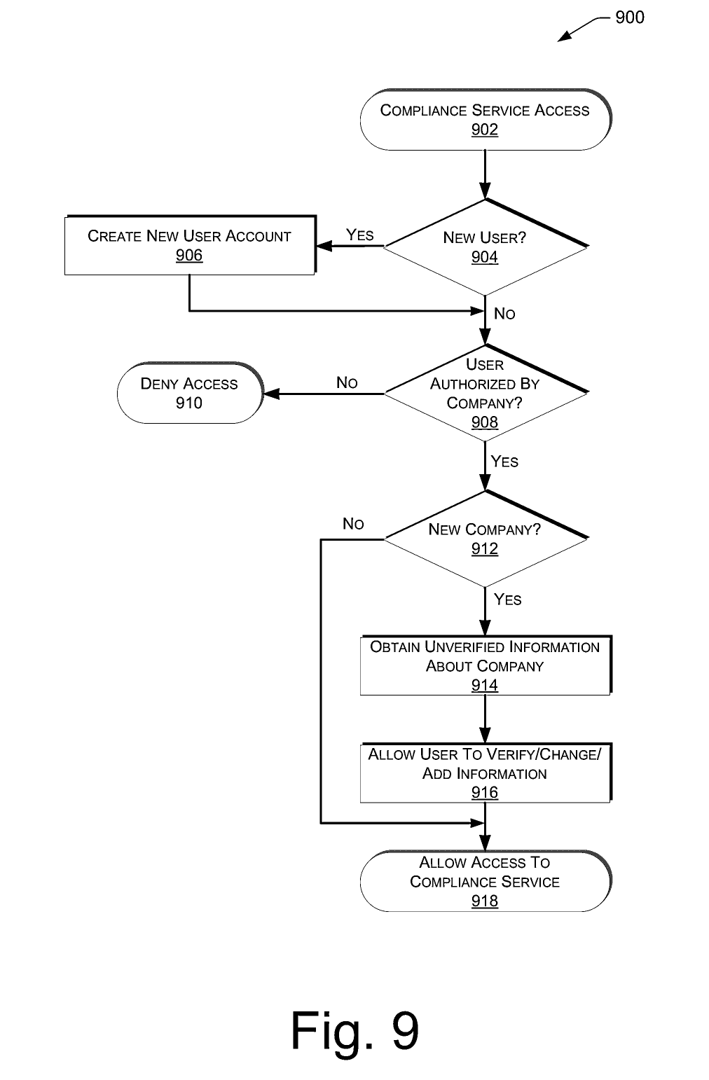

FIG. 9 is a flow diagram of an example process 900 for providing access to a compliance service, according to an implementation. The process 900 and each of the other processes described herein are illustrated as a collection of blocks in a logical flow graph. Some of the blocks represent operations that can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded or uploaded through the Internet or other networks. Finally, the order in which the operations are described is not intended to be construed as a limitation, and any number of the described operations can be combined in any order and/or in parallel to implement the process. Likewise, additional or fewer operations than those described may be utilized with the various implementations described herein.

The example process 900 for providing access to a compliance service begins upon receiving a request to access the service, as in 902. Upon receiving an access request, a determination is made as to whether the requesting user is a new user, as in 904. If it is determined that the user is a new user, a new user account is created for that user, as in 906. In some implementations, creation of a new user account may require authorization by another user associated with the company before the new user account can be created and associated with that company. In other implementations, the user account may be created and later authorized before access to company information provided.

Upon creation of a new user account or if it is determined that the user requesting access to the compliance service is not a new user, a determination is made as to whether the user is authorized by the company for which they are requesting access, as in 908. As noted above, in some implementations a user may be associated with, or a member of, multiple work groups, each work group associated with a different company. In other implementations, as a user is requesting access to the compliance service, the user may identify the company for which they desire access. If it is determined that the user requesting access to the compliance service is not authorized by the company, access to the company related information is denied, as in 910.

If it is determined that the user is authorized by the company to access the compliance service, a determination is made as to whether the company itself is a new company with respect to the client service, as in 912. For example, the company may be joining or otherwise starting participation in the compliance service and therefore may be considered a new company. If it is determined that the company is a new company, information about the company may be obtained, as in 914. For example, in some implementations publicly available information, also referred to herein as unverified information, may be obtained from one or more external sources. Unverifiable information may be obtained from a multitude of sources. For example, unverified information may be obtained from public sources, such as news agencies, or from other third parties that maintain information about the company. Automatically obtaining information about a new company rather than requiring the user to manually provide the information simplifies the process of collecting information about the company.

Obtained unverified information about the company may then be provided to the user so the user has an opportunity to modify, change, delete, supplement and/or verify the information, as in 916. In some implementations, the process steps 914 and 916 of collecting unverified information about the company and allowing a user to verify or change that information may be omitted from the compliance service access process 900. In such an implementation, the unverified information about the company may be collected and later updated, modified, deleted, and/or verified by a user while using the compliance service. If it is determined that the company for which the user is requesting access is not a new company or after collecting information about the company and allowing user to verify the information, access to the compliance service is provided to the user, as in 918.

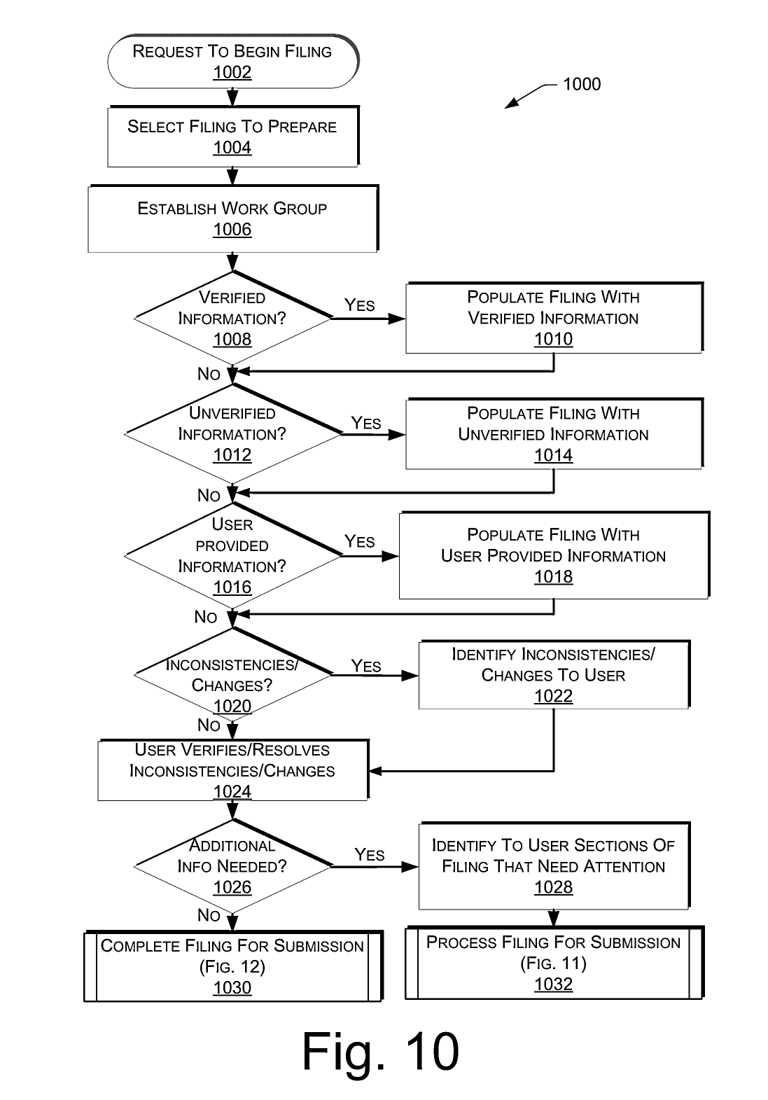

FIGS. 10-12 is a flow diagram of an example process 1000 for preparing a filing for submission to a receiving entity, according to an implementation. The process 1000 begins upon receiving a request to begin a filing on behalf of the company, as in 1002. Upon receiving a request to begin a filing on behalf of the company, a filing that is to be prepared is selected by the user, as in 1004. As discussed above, numerous filings with various different receiving entities in multiple different countries may be available for selection by user. The user may either directly select or otherwise search for and identify a filing that is to be prepared or review information on the different filings to assist in the identification and selection of the appropriate filing.

In addition to selecting a filing to prepare, a work group may be established, as in 1006. In some implementations, a work group may be previously defined for a company and/or for one or more filings that are to be prepared for the company. In such an instance, establishment of the work group may be associating an existing work group with the filing that is to be prepared. In other implementations, establishing a work group may include a user specifying or otherwise identifying other users of the compliance service that are to be included in a work group and participate in the preparation of the filing on behalf of the company. The users may include personnel of the company and non-company personnel (e.g., external lawyers, accountants, advisors) that provide support in preparing the filing.

A determination may also be made as to whether the client service includes verified information that can be used in preparing the filing, as in 1008. As discussed above, verified information may be, but is not limited to, information obtained from other sources and verified by a user authorized by the company, previously provided by the company or a user associated with the company, or used in preparing previous filings. If it is determined that the compliance service has access to verified information, at least a portion of the filing may be automatically populated with the relevant verified information, as in 1010.

If it is determined that there is no verified information for use with the filing, or after obtaining and automatically populating the filing with available verified information, a determination is made as to whether the compliance service maintains unverified information that may be used in preparing the selected filing, as in 1012. If it is determined that there is unverified information available to the compliance service, that unverified information may be used to automatically populate the relevant portions of the filing that have not already been populated with the verified information, as in 1014.

If it is determined that there is no unverified information available to the compliance service, or after automatically populating the selected filing with relevant unverified information, a determination is made as to whether the user has provided any information for use in preparing the selected filing, as in 1016. If it is determined that the user has provided information for use in preparing the filing, that information may be used to automatically populate portions of the filing with the relevant user provided information, as in 1018.

If it is determined that there is no user provided information or after automatically populating the filing with user provided information, a determination is made as to whether there are any data inconsistencies or changes between information that has been used to populate various sections of the filing, as in 1020. For example, if a section of a filing has been automatically populated with verified information, as in 1010, and the user also provided information relevant to that section which is inconsistent with the verified information, the example process 1000 may determine that an inconsistency/changes between information exists.

If it is determined that one or more inconsistencies/changes exist, the example process 1000 may identify those complex to the user as in 1022.

Upon identifying any inconsistencies/changes to the user, or if it is determined that no inconsistencies/changes exist, the user may verify any included unverified information and resolve any identified inconsistencies/changes, as in 1024. In some implementations, any unverified information included in a filing that is being prepared may be identified as needing verification from a user before the filing can be completed for submission. A user may verify any unverified information or resolve any identified inconsistencies/changes as in 1024 or, as discussed below, assign those sections of the filing to other users of the work group associated with the filing for the company.

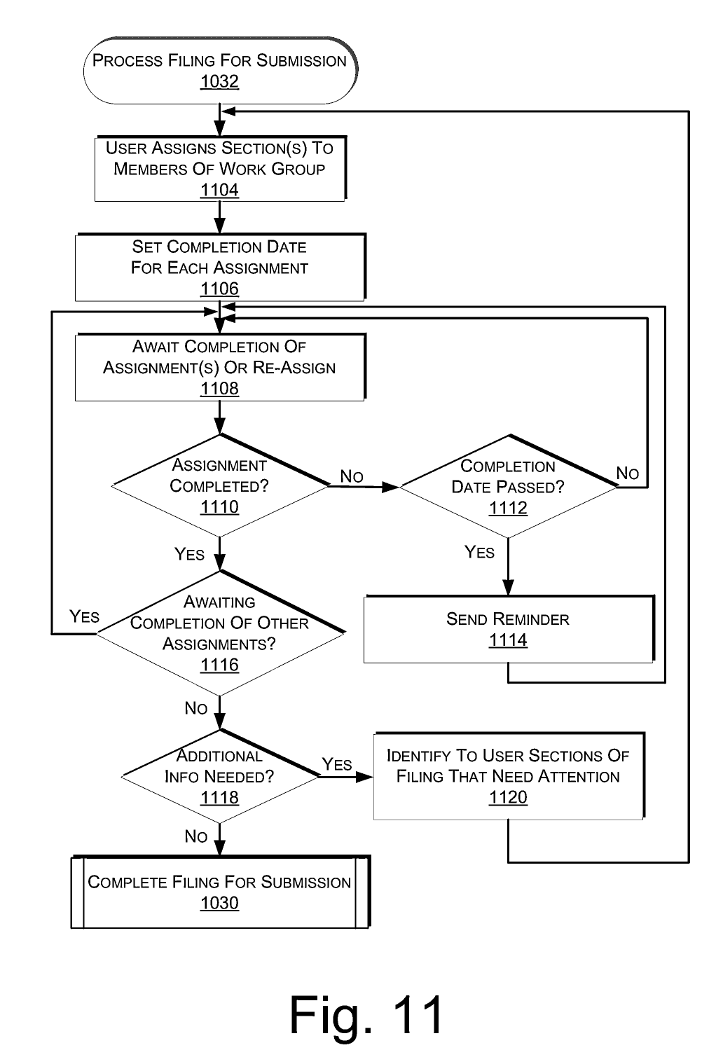

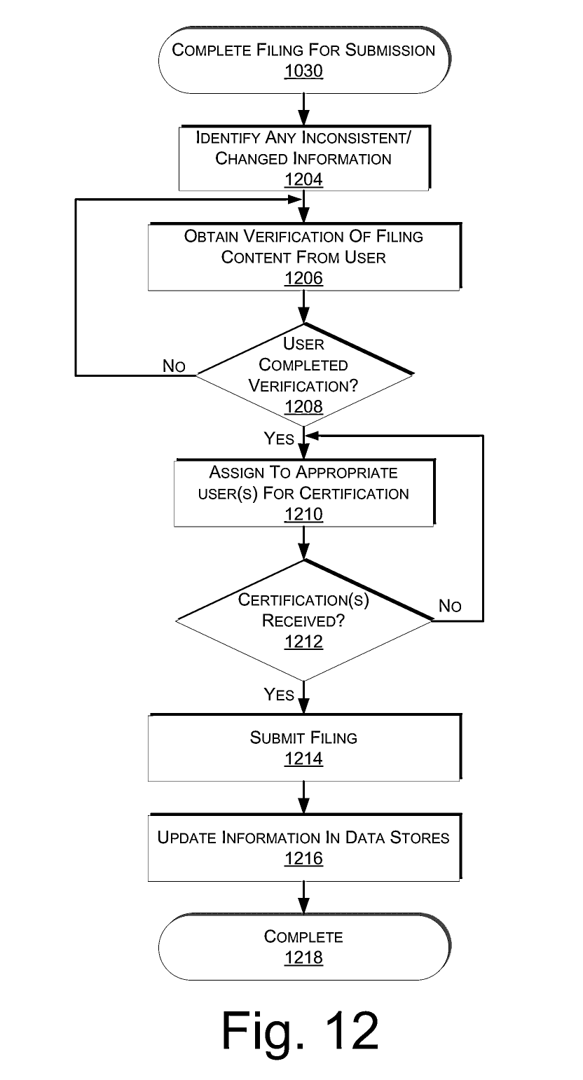

After the user has verified any unverified information, resolved any identified inconsistencies/changes and or chosen to continue preparing the filing, a determination is made as to whether any additional information is needed in order to complete the filing for submission, as in 1026. Additional information may be, but is not limited to, verification of unverified information, missing information, incomplete sections of a filing and/or inconsistent/changed information that needs to be resolved. If it is determined that additional information is needed, the example process 1000 may identify to the user the sections of the filing that need attention, as in 1028, and continue to the subroutine of processing filings for submission, as in 1032. The subroutine of processing filings for submission is described in further detail below with respect to FIG. 11. If it is determined that no additional information is needed, the example process 1000 continues to the subroutine for completing a filing for submission, as in 1030. The subroutine for preparing a filing for submission is described in further detail below with respect to FIG. 12.

FIG. 11 is a flow diagram of an example subroutine 1100 for processing a filing for submission, according to an implementation. Continuing with the discussion above, the subroutine for processing a filing for submission 1100 begins by a user assigning one or more sections to user members of the work group established for the selected filing, as an 1104. For each assignment, the user may specify a completion date or a duration during which the section will be shared with the member of the work group that is receiving the assignment, as in 1106. In some implementations, assignment of sections of the filing may be transitioned to other members of the work group by the compliance service maintaining an ownership list identifying different sections of the filing and who is responsible for completing those sections. Information identifying which member is responsible for completing each section of the filing may be identified to the various members of the work group associated with the filing and reminders provided to the user that created each assignment informing them of the progress on the various assignments. For example, in some implementations, a user may be able to view a completion percentage identifying how much of an assignment has been completed. In other implementations, users may be able to view the amount of time remaining before the assignment is to be completed.

After the user has assigned sections of the filing that need attention, the example subroutine process 1100 may await completion of the one or more assignments, as in 1108. Optionally, a user may reassign one or more assignments to another member of the work group, as in 1108. For example, after a user is assigned a section of a filing, the user may decide to either completely reassign the assignment to another user of the work group or add another user to the assignment. If the user desires to completely reassign the assignment, the user to which the assignment was originally assigned may be removed from the assignment and the assignment effectively re-created and sent to a new user member of the work group. Alternatively, one or more additional users may also be included as part of the assignment such that any one of the assigned user members of the work group can complete the assignment.

The example subroutine process 1100 may periodically determine whether an assignment has been completed, as in 1110. If it is determined that the assignment has not been completed, a determination may be made as to whether the completion date associated with the assignment has passed, as in 1112. If it is determined that that the completion date associated with the assignment has passed, the example subroutine process 1100 may send a reminder to the user member of the work group to which the assignment was assigned and/or send a reminder to the user that issued the assignment reminding them that the assignment has not been completed, as in 1114. Upon sending a reminder, or if it is determined that the completion date associated with the reminder has not passed, the example process returns to block 1108 and continues.

If it is determined at decision block 1110 that an assignment has been completed, a determination is made as to whether other assignments associated with the filing still need to be completed, as in 1116. If it is determined that other assignments still need to be completed for the filing, the example subroutine process 1100 returns to block 1108 and continues. If it is determined that there are no remaining assignments associated with the filing, a determination is made as to whether any additional information is needed to complete the filing, as in 1118. If it is determined that additional information is still needed to complete the filing, the sections of the filing that still need attention are identified to the user, as in 1120, and the example subroutine process 1100 returns to block 1104 and continues. If it is determined that no additional information is needed to complete processing of the filing for submission, the example subroutine process 1100 continues to the subroutine for completing a filing for submission, as in 1030 (discussed below with respect to FIG. 12).

FIG. 12 is a flow diagram of an example subroutine process 1030 for completing a filing for submission to a receiving entity, according to an implementation. Continuing with the above example, once all the information necessary for completing the filing has been received, the example subroutine process 1030 for completing the filing for submission may be performed. As a final check, any remaining inconstant/changed information may be identified, as in 1204. If there is any remaining inconsistent/changed information, it may be identified to the user for resolution. Once any remaining inconsistencies have been resolved, a final verification of the filing content is obtained from a user authorized by the company for which the filing is being prepared, as in 1206. In some implementations, the verification may be done by a single user authorized by the company to verify content in a filing. In other implementations, multiple users may be required for verification.

Once a user has provided verification, a determination may be made as to whether all verification for the content included in the filing has been completed, as in 1208. If it is determined that all verifications have not been received, the example subroutine process 1200 returns to block 1206 and continues. If it is determined that all verifications have been received, the filing is assigned to the appropriate user(s) associated with the company for certification, as in 1210. Assignments may be done automatically once all verifications have been received. In other implementations, assignment for certification may be done manually. Some receiving entities may require certification of filings by senior management of the company before they can be submitted. Likewise, in some instances, receiving entities require certification from multiple representatives of the company. In such instances, the example subroutine process 1200 may assign the filings, or portions thereof, to the relevant users for the appropriate certifications. In some implementations, the user may provide the needed certifications by reviewing the filing and providing a confirmation to the compliance service.

After the filing has been assigned to the one or more users for certification, a determination is made as to whether the necessary certifications have been received, as in 1212. If it is determined that the necessary certifications have not been received, the example subroutine process 1200 returns to block 1210 and continues. However, if it is determined that all the necessary certifications have been received, the filing may be completed and submitted to the appropriate receiving entity, as in 1214.

Submission of the filing to the appropriate receiving entity may be done in a variety of ways. For example, in some implementations, the compliance service may interact directly with the receiving entity (e.g., through a standardized API protocol) and allow the user to directly submit the filing to the receiving entity through the compliance service. In other implementations, the content necessary for the filing may be formatted according to specifications of the receiving entity so that the user can submit the information directly to the receiving entity. In still other examples, the information may be printed out and delivered directly to the receiving entity.

In addition to providing the ability for the user to submit the filing to the receiving entity, the information included in the filing and verified by the user members of the work group during preparation of the filing is stored in the company data store 108 and/or information data store 110 and identified as verified information. The stored verified information may then be used for later filings of the company, with the same or different receiving entities, to automatically populate portions, or all of the filing. Once the information has been updated in the data stores of the compliance service the example subroutine process 1200 completes, as in 1218.

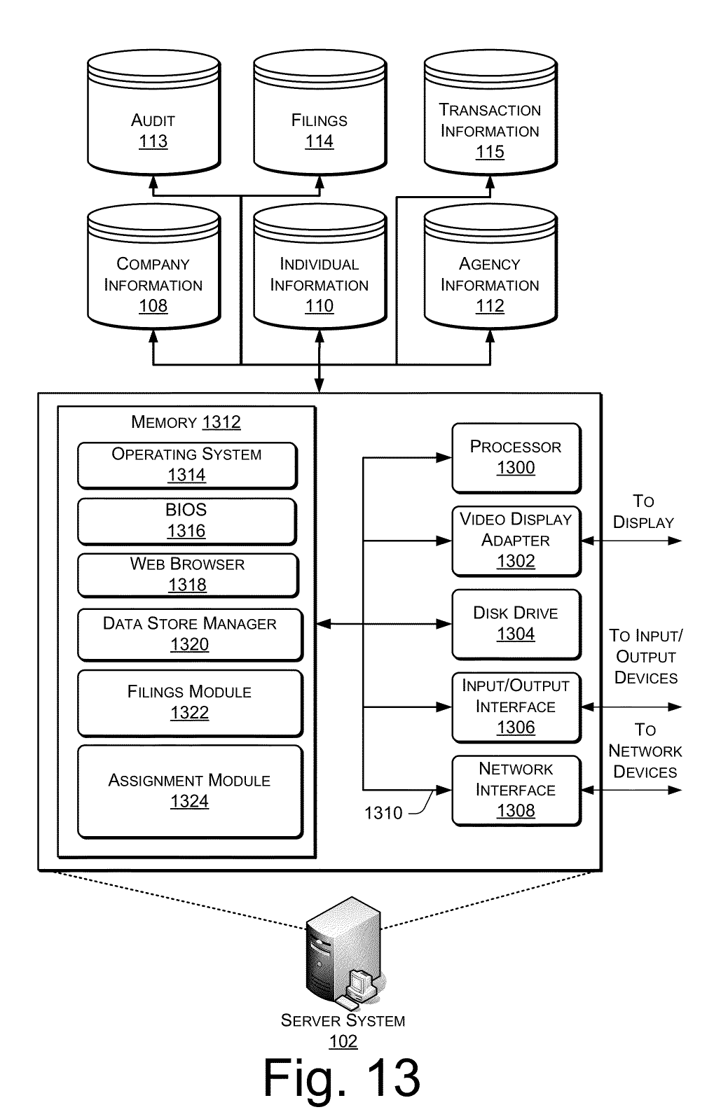

FIG. 13 is a pictorial diagram of an illustrative implementation of a server system, such as the server system 102, that may be used in the computing environment of FIG. 1. The server system 102 may include a processor 1300, such as one or more redundant processors, a video display adapter 1302, a disk drive 1304, an input/output interface 1306, a network interface 1308, and a memory 1312. The processor 1300, the video display adapter 1302, the disk drive 1304, the input/output interface 1306, the network interface 1308, and the memory 1312 may be communicatively coupled to each other by a communication bus 1310.

The video display adapter 1302 provides display signals to a local display (not shown in FIG. 13) permitting an operator of the server system 102 to monitor and configure operation of the server system 102. The input/output interface 1306 likewise communicates with external input/output devices not shown in FIG. 13, such as a mouse, keyboard, scanner, or other input and output devices that can be operated by an operator of the server system 102. The network interface 1308 includes hardware, software, or any combination thereof, to communicate with other computing devices. For example, the network interface 1308 may be configured to provide communications between the server system 102 and other computing devices, such as the client device 104, via the network 106, as shown in FIG. 1.

The memory 1312 generally comprises random access memory (RAM), read-only memory (ROM), flash memory, and/or other volatile or permanent memory. The memory 1312 is shown storing an operating system 1314 for controlling the operation of the server system 102. A binary input/output system (BIOS) 1316 for controlling the low-level operation of the server system 102 is also stored in the memory 1312.

The memory 1312 additionally stores program code and data for providing network services that allow client devices 104, public sources 118 and receiving entities 128 to exchange information and data files with the server system 102. Accordingly, the memory 1312 may store a browser application 1318. The browser application 1318 comprises computer executable instructions that, when executed by the processor 1300 generate or otherwise obtain configurable markup documents such as Web pages. The browser application 1318 communicates with a data store manager application 1320 to facilitate data exchange and relationship mapping between the company information data store 108, the individual information data store 110, the user information data store 112, audit data store 113, filings data store 114, transaction information data store 115, or any combination thereof, client devices 104 and/or receiving entities 128.

Additionally, the memory 1312 may also include a filing module 1322 and an assignment module 1324. The modules 1322, 1324 may be executable by the processor 1300 to implement one or more of the functions of the server system 102. In one implementation, each of the modules 1322, 1324 may represent instructions embodied in one or more software programs stored in the memory 1312. In another implementation, the modules 1322, 1324 can represent hardware, software instructions, or a combination thereof

In some implementation, the filing module 1322 is configured to interface with the various data stores, a user of the client device 104 and/or the receiving entities to prepare filings for submission to one or more receiving entities. In one example, as discussed above, the filing module 1322 may implement the example processes discussed above. In some implementations, the filing module 1322 may provide one or more user interfaces to facilitate interaction with a user as part of the preparation of a filing for a receiving entity.

The assignment module 1324 may be configured to interact with the filing module 1322 and respond to a user assigning a portion of a filing to another user, assign that corresponding portion and manage the completion and return of that portion of the filing. In one example, as discussed above with respect to FIG. 13, the assignment module 1324 may implement a portion of the example process, manage assignment of portions of the filing and, as appropriate, send reminders regarding the assigned sections.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
under control of one or more computing devices configured with executable instructions,
identifying information about a company;
automatically populating a filing to be submitted to a receiving entity with the identified information;
determining that additional information is needed to complete the filing;
assigning a section of the filing for completion of the additional information;
finalizing the filing for submission to the receiving entity; and
submitting the finalized filing to the receiving entity.

2. A method as recited in claim 1, further comprising:
maintaining information included in the finalized filing in one or more data stores, wherein the maintained information may be included as identified information for use in completing an additional filing for the company.

3. A method as recited in claim 1, wherein the identified information is obtained at least in part from a publically available source.

4. A method as recited in claim 1, wherein the identified information is obtained from a user.

5. A method as recited in claim 1, further comprising:
determining that at least one item of the identified information is inconsistent with information provided by a user.

6. A method as recited in claim 1, further comprising:
creating a work group that includes a plurality of individuals; and
wherein assigning a section of the filing for completion of the additional information includes assigning a section of the filing to at least one individual of the work group.

7. A method as recited in claim 6, wherein at least one individual of the plurality of individuals in the work group is not affiliated with the company.

8. A method as recited in claim 6, further comprising:
establish a calendar entry associated with the assigned section.

9. One or more computer readable media storing computer-executable instructions that, when executed on one or more processors, cause the one or more processors to perform acts comprising:
determining that a first filing to be submitted to a first receiving entity has been completed;
causing the completed first filing to be submitted to the first receiving entity;
associating information included in the completed first filing with a company;
storing the associated information in a data store; and
using a least a portion of the stored associated information to provide information for completing a second filing to be submitted to a second receiving entity.

10. One or more computer readable media as recited in claim 9, wherein the first receiving entity and the second receiving entity are different.

11. One or more computer readable media as recited in claim 9, wherein the information includes at least one of company information, personnel information or transaction information.

12. One or more computer readable media as recited in claim 9, wherein the stored associated information is a personnel information; and
the computer-executable instructions that, when executed on one or more processors, further cause the one or more processors to perform acts comprising:
determining that an individual represented by the personnel information is now associated with a second company; and
associating the personnel information with the second company.

13. One or more computer readable media as recited in claim 12, wherein the second filing is completed for the second company.

14. One or more computer readable media as recited in claim 12, wherein the first filing was at least partially completed based at least in part on information associated with the company and previously stored in the data store.

15. One or more computer readable media as recited in claim 14, wherein causing the completed first filing to be submitted to the first receiving entity includes, obtaining a certification that the information included in the first filing is accurate.

16. One or more computer readable media as recited in claim 14, wherein causing the completed first filing to be submitted to the first receiving entity includes, electronically submitting the first filing to the receiving entity.

17. A non-transitory computer readable storage medium storing instructions for preparing a filing for submission to a receiving entity, the instructions when executed by a processor causing the processor to:
identify verified information associated with a company;
populate at least a portion of the filing based on the verified information;
determine that at least a portion of the filing is not complete;
receive additional information needed to complete the filing; and
prepare the filing for submission to the receiving entity.

18. The non-transitory computer readable storage medium of claim 17, the instructions when executed by the processor further cause the processor to:
identify unverified information about the company; and
populate at least a portion of the filing based on the unverified information.

19. The non-transitory computer readable storage medium of claim 18, wherein the instructions when executed by the processor causing the processor to receive additional information needed to complete the filing further cause the processor to:
assign at least a section of the filing to a user for completion.

20. The non-transitory computer readable storage medium of claim 19, wherein the user is not an employee of the company.

21. The non-transitory computer readable storage medium of claim 19, wherein the user provides information for a plurality of companies.
